(19) United States
(12) Patent Application Publication
(10) Pub. No.: US 2002/0093883 A1
(43) Pub. Date: Jul. 18, 2002

(54) Structure of pick-up head and its method for accessing signals

(76) Inventors: Hung-Lu Chang, Taichung City (TW); Jau-Jiu Ju, Hsinchu Hsien (TW); Der-Ray Huang, Hsinchu City (TW); Yuh-Fwu Chou, Hsinchu Hsien (TW); Richard Wu, Hsinchu City (TW)

Correspondence Address: BIRCH STEWART KOLASCH & BIRCH, PO BOX 747, FALLS CHURCH, VA, 22040-0747, US

(21) Appl. No.: 10/014,489

(22) Filed: Dec. 14, 2001

(30) Foreign Application Priority Data
Jan. 12, 2001 (TW) 90100676

(51) Int. Cl. G11B 11/00; G11B 7/00

(52) U.S. Cl. 369/13.56; 369/53.31

(57) ABSTRACT

The present invention pertains to a structure of pick-up head and its method for accessing signals, which operates in coordination with a disk made by ferroelectric material. An electric field is generated around the ends of two conductive wires by exerting a voltage on the wires. When the ends of the two wires are being close to the disk, the electric field polarizes the data-storing surface, which is formed by the ferroelectric material, so as to reach the function of writing. And as reading is needed, the two wires are also utilized of being induced by the electric lines of polarized area on the ferroelectric material to solve the data signals stored on the disk. Because the structure of pick-up head is simple and it is able to generate a smaller effective electric field, it is advantaged for the trend of miniaturization of pick-up head and capable of increasing the density of data on the disk.

### BACKGROUND OF THE INVENTION

1. Field of Invention

The present invention relates to a structure of pick-up head and its method for accessing signals, in particular, which operates in coordination with the characteristics of ferroelectric material, and utilizes the inducing of electric field to develop a structure of pick-up head capable of optical reading/electric writing or electric reading/electric writing and its method for accessing signals.

2. Related Art

Current magnetic storage media, like a hard disk (HD) or a magneto-optical (MO) disk, utilize two different directions of magnetic field to magnetize the magnetic substances among it, and after magnetizing, the polarizations of the magnetic substances separately indicate data 0 and data 1. There are different degrees of difficulty if the magnetism of a magnetic substance needs to be changed. The lower the coercivity of the magnetic substance is, the easier the magnetism is changed. For example, the coercivity of the magnetic substances in floppy disk and hard disk is not high enough, so that it is very possible of the data among them being destroyed if they are put in a certain magnetic field. However, the magnetic substances used in MO their coercivity is ten times as high as one in floppy disk. It means that the data recorded in MO is not easy to be disturbed and destroyed by other magnetic field outside. Oppositely, it also needs ten times intensity of magnetic field to write new data into MO. The situation described above is tough for making a tiny pick-up head, because it is necessary to make a pick-up head smaller and smaller so as to access high-density data in media.

Nevertheless, rising temperature will cause the reducing of the coercivity of the magnetic substances, and when it reaches a certain critical temperature (called Curie Temperature, between 180 centigrade degrees to 200 centigrade degrees), the magnetic substances will change qualities of themselves to turn into non-permanent magnets, and then if the temperature is cooled down under the critical temperature, the magnetic substances will be restored to permanent magnets again. Therefore, MO uses laser light to heat the surface of disks. When a point of the magnetic substances is heated to approach the Curie Temperature, the magnetism of the point will be changed cooperating with the magnetic field generated by the pick-up head in MO. After cooling down the magnetic substances, the new magnetism will be preserved.

Because MO utilizes coils to generate a magnetic field to write down data, it is hard to restrict the points of writing area to be very tiny in order to increase the density of data storing. Moreover, it is necessary of operating with laser light for heating, so the structure of the pick-up head is complicated and not easy to miniaturize.

Furthermore, the ferroelectric material is a kind of dielectric material. When an electric field exerts on the ferroelectric material, the Polarization-to-Electricfield's curve (called PE curve for short) shows a hysteresis phenomenon. Hence, the polarization is able to be lingered even if the electric field is removed. Taking advantage of the characteristic capable of keeping polarization, the ferroelectric material is able to store digital data, which separately means “1” and “0”, through “polarizing” and “unpolarizing” or different directions of polarization.

### SUMMARY OF THE INVENTION

In view of the foregoing, it is an object of the invention to provide a simple structure of pick-up head basing on the disk made by ferroelectric material, and the pick-up head is able to read and write the data on the disk through the way of polarizing the ferroelectric material.

Pursuant to the above object, the invention provides a structure of pick-up head and its method for accessing signals. The structure includes a signal-writing unit, a signal-processing unit, a switch and a pair of conductive wires wherein the ends of the wires are close but separate to a gap. When the pick-up head performs the function of writing, the signal-writing unit exerts a voltage on the pair of wires to let the ends generate an electric field around the gap so as to polarize the data-storing surface on the disk. When the pick-up head performs the function of reading, the switch is turned to let the signal-processing unit connect with the pair of wires. There is not any voltage exerted on the wires at this time. On the other hand, the ends of the wires are approached the data-storing surface to induce the situation of polarizing, and then the electric signals read from the disk are transmitted to the signal-processing unit.

Furthermore, the structure of the pick-up head is also capable of adopting a way of optical reading/electric writing. Wherein the way of electric writing is as same as above, but laser light is used instead to be the way of reading. The E-O Coefficient of the ferroelectric material is changed after polarizing, so the content of signals read from the disk is able to be known through distinguishing the E-O Coefficient of reflection.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1A shows a schematic view of the present invention for writing data on the disk made by ferroelectric material.

FIG. 1B shows a schematic view of the present invention for reading data on the disk made by ferroelectric material.

FIG. 2 shows a schematic view of the first embodiment of the pick-up head.

FIG. 3 shows a schematic view of the second embodiment of the pick-up head.

### DETAILED DESCRIPTION OF THE INVENTION

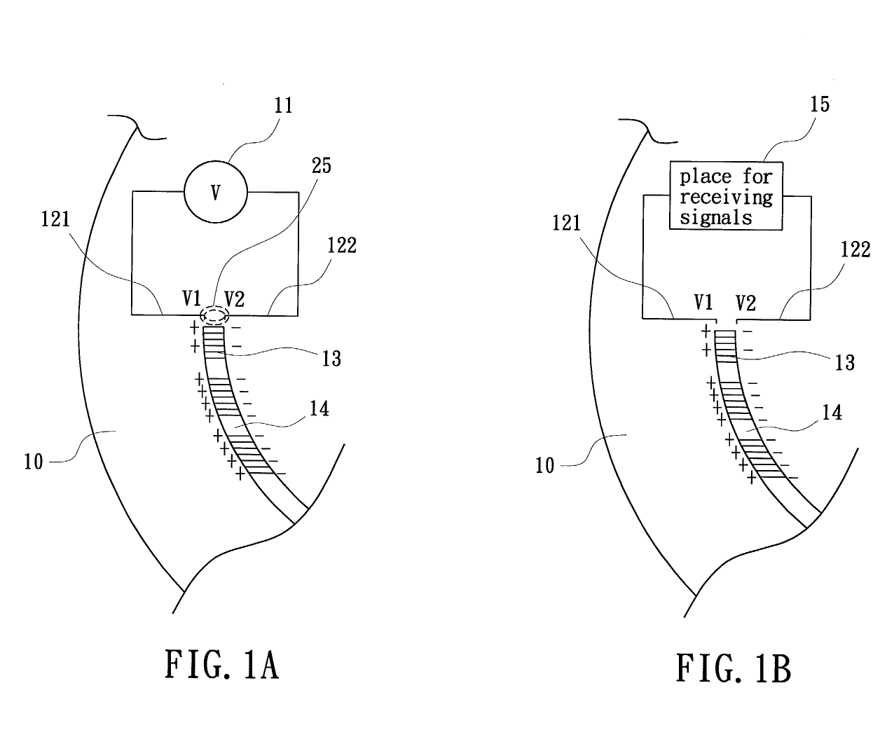

With reference to FIG. 1A, basing on the memorizing characteristics of ferroelectric material described above, the present invention comes up a disk 10, which is plated with the ferroelectric material, to be the media of storing data. Wherein the part plating with the ferroelectric material is the data-storing surface of the disk 10. The principles of writing data are described as following: First, exerting a voltage 11 on a pair of conductive wires (the first wire 121 and the second wire 122), wherein the ends of the wires 121,122 are close but separate to a gap. Because of the voltage 11, the ends of the conductive wires 121,122 generate a microelectrode and the microelectrode generates an electric field 25 around the gap. If the electric field 25 is moved to near the data-storing surface of the disk 10, the ferroelectric material will be induced and then polarized. But one thing should be noticed that the ends of the first wire 121 and the second wire 122 could not touch the disk 10. Therefore, there is an electric field or no can be controlled by a switch of the voltage 11 so that the ferroelectric material plated on the disk 10 is divided into polarizing areas and unpolarizing areas. The present invention utilizes the difference to store digital data of representing 0 and 1.

Otherwise, the way of storing data is also able to be achieved by the method of changing the voltage-reducing direction. For example, let V₁>V₂ or V₁<V₂ in the FIG. 1A so the directions of the electric fields 25 will be different. The ferroelectric material plated on the disk 10 also is also able to induce two kinds of areas of different directions of polarization so as to store digital data of representing 0 and 1.

With reference to FIG. 1B, when the data on the disk 10 is needed to be read, the first wire 121 and the second wire 122 will not be exerted any voltage 25, but the ends of the wires 121,122 are still moved to near the data-storing surface on the disk 10 so as to draw the electric lines generated by the polarized electric charges. Similarly, one thing should be noticed that the ends of the first wire 121 and the second wire 122 could not touch the disk 10. After drawing the electric lines, there is a potential difference generated in the ends of the first wire 121 and the second wire 122. The signal of the potential difference is transmitted to a place of receiving signals 15. The place of receiving signals 15 is capable of knowing the signal being from a polarizing area 13 or an unpolarizing area 14 by determining that there is a potential difference or not. For this reason, the data content of the signal is able to be solved. Otherwise, it is also possible to read a signal of V₁>V₂ or V₁<V₂, which mean signals coming from two data areas of different directions of polarization. It also works to determine the data content on the disk 10.

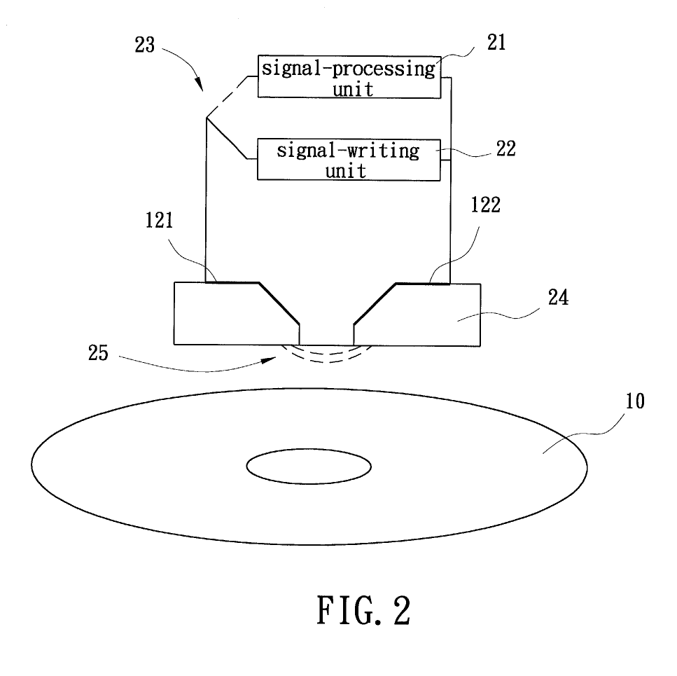

Therefore, basing on the principles of writing and reading signals described above, the present invention comes up a structure of pick-up head showing as FIG. 2, which applies the way of electric reading/electric writing to access the disk 10 plated with the ferroelectric material. The disk 10 is capable of being rotated like a current hard disk. The pick-up head has a signal-writing unit 22, which is able to generate a regular voltage while the pick-up head performs the function of writing. The voltage lets the ends of the first wire 121 and the second wire 122 generate an appropriate electric field 25 so as to polarize the data-storing surface made by the ferroelectric material on the disk 10. And while the pick-up head performs the function of reading, a switch 23 is further used to shift the controlling right to a signal-processing unit 21. There is not any voltage exerted on the pair of wires 121,122 at this time. On the other hand, the ends of the pair of wires 121,122 are moved to an appropriate position above the data-storing surface in order to sense the situation of polarizing, and then the electric signals read from the disk 10 are transmitted to the signal-processing unit 21 for further processing. Moreover, The pick-up head further has a pedestal 24 for fixing the relative position of the first wire 121 and the second wire 122 so that it is easier to control and remove the pair of wires 121,122 in order to reach the goal of accessing signals.

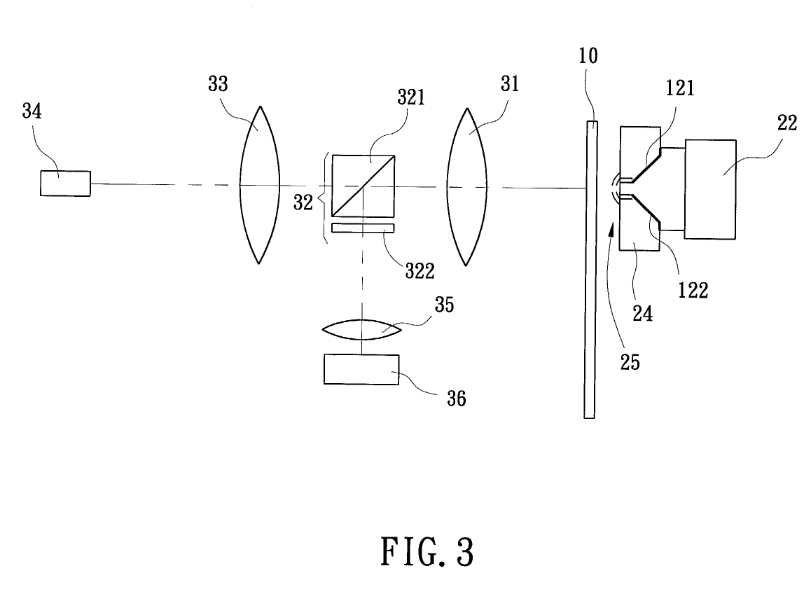

In addition to utilizing the principle of electric reading/electric writing to be the structure of pick-up head, the present invention also applies the way of optical reading/electric writing to access the disk 10 plated with the ferroelectric material. With reference to FIG. 3, wherein the method of writing signals is as same as above, but the part of reading signals adopts the structure of optical pick-up head. While the pick-up head performs the function of reading, first, a laser diode 34 emits a laser beam (called linear polarized light), which passes through a collimator 33 to be turned into a parallel beam, and parallel beam passes through a polarization beam splitter 32 (consist of a beam splitter cube 321 and a polarizer 322) and an object lens 31, and then it is focused on the disk 10. Afterwards, the reflective beam, polarization beam splitter 32 also passes through the object lens 31, the polarization beam splitter 32. Wherein at the time of the reflective beam arrives the polarization beam splitter 32, its optical path is divided from the optical path of the former laser beam and then reaches a focusing lens 35. The focusing lens 35 focuses the reflective beam on a photodetector 36 so as to translate the reflective beam to an electric signal. Because the E-O Coefficient of the ferroelectric material will vary after polarizing and it causes the polarization of the reflected beam changed, the photodetector 36 is able to distinguish the content of the disk 10 just according to the change of the E-O Coefficient.

Furthermore, no matter which embodiments described above, the structure of pick-up head disclosed in the present invention is able to limit the electric field 25 to a smaller area while writing signals, and the electric field 25 is also utilized to writing signals. It is not necessary to use laser light to assist in heating like current MOs. Of course, if there is any request, the structure of pick-up head disclosed in the present invention is also capable of adding the method of work: taking the laser light to heat the data-storing surface and cooperating with the electric field 25 to do the action of writing.

As to the efficiency of the present invention is described as following:

1. The structure of pick-up head is simple that only needs two conductive wires to write or read data. The process of writing data does not need laser light to heat up like current MOs, so it provides with the advantages of reducing cost and miniaturizing the size of pick-up head.

2. The present invention just utilizes two conductive wires to polarize the data-storing surface on the disk. Comparing with current MOs which generate magnetic fields by coils to write signals, the pick-up head disclosed in the present invention is able to access very tiny data point. So the storage capacity of the disk is larger.

3. Due to the disk plated with the ferroelectric material disclosed in the present invention, its structure and manufacture's principle are almost as same as current hard disks and MOs. Only the material of the data-storing surface is different, so the compatibility is high.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A structure of pick-up head, which utilizes the way of electric reading/electric writing to access data on a disk provided with ferroelectric material, the structure comprising:
a signal-writing unit for providing a voltage to write down signals on the disk;
a signal-processing unit for coping with electric signals read from the data-storing surface on the disk; and
a pair of conductive wires extended from the signal-writing unit and the signal-processing unit, wherein the ends of the wires are close but separate to a gap, the signal-writing unit exerts a voltage on the wires to let the ends generate a electric field around the gap so as to polarize the data-storing surface on the disk to perform the function of writing; and when the function of reading is performed, the ends of the wires are approached the data-storing surface to induce the situation of polarizing, and then the electric signals read from the disk are transmitted to the signal-processing unit.

2. The structure according to claim 1, wherein the pick-up head further comprises a switch for determining the pair of wires being connected with the signal-writing unit or the signal-processing unit.

3. The structure according to claim 1, wherein the pick-up head further comprises a pedestal for fixing the pair of wires so as to control the positions of the ends of the wires.

4. A structure of pick-up head, which utilizes the way of optical reading/electric writing to access data on a disk provided with ferroelectric material, the structure comprising:
a signal-writing unit for providing a voltage to write down signals on the disk;
a pair of conductive wires extended from the signal-writing unit, wherein the ends of the wires are close but separate to a gap, the signal-writing unit exerts a voltage on the wires to let the ends generate a electric field around the gap so as to polarize the data-storing surface on the disk to perform the function of writing;
a laser diode for emitting a laser beam to read the signals written by the pair of conductive wires;
an object lens for focusing the laser beam on the data-storing surface on the disk to turn into a reading optical point; and
a photodetector for translating a reflective beam from the reading optical point into a electric signal.

5. The structure according to claim 4, wherein the pick-up head further comprises:
a collimator for coping with the laser beam emitted from the laser diode into a parallel optical beam;
a polarization beam splitter for separating the laser beam emitted from the laser diode and the reflective beam from the reading optical point; and
a focusing lens for focusing the reflective beam from the polarization beam splitter on the photodetector.

6. The structure according to claim 4, wherein the pick-up head further comprises a pedestal for fixing the pair of wires so as to control the positions of the ends of the wires.

7. A method for accessing signals applied in pick-up head, which utilizes the way of electric reading/electric writing to access data on a disk provided with ferroelectric material, the method comprising:
exerting a voltage on a pair of conductive wires while writing, the ends of the conductive wires generate a microelectrode and the microelectrode generates a electric field;
letting the electric field generated by the microelectrode approach the disk so as to polarize the data-storing surface made by the ferroelectric material to write down signals;
unexerting a voltage on the pair of conductive wires while reading, and utilizing the ends of the conductive wires to induce the polarized electric charges on the data-storing surface; and
processing electric signals which individually represent the polarized electric charges.

8. The structure according to claim 7, wherein utilizes the polarizing area and unpolarizing area or different directions of polarization on the data-storing surface to represent digital data 1 and 0.

9. The structure according to claim 7, wherein the pick-up head further comprises a pedestal for fixing the pair of wires so as to control the positions of the ends of the wires.

10. A method for accessing signals applied in pick-up head, which utilizes the way of optical reading/electric writing to access data on a disk provided with ferroelectric material, the method comprising:
exerting a voltage on a pair of conductive wires while writing, the ends of the conductive wires generate a microelectrode and the microelectrode generates a electric field;
letting the electric field generated by the microelectrode approach the disk so as to polarize the data-storing surface made by the ferroelectric material to write down signals;
casting a laser beam while reading, the laser beam passes through an object lens and focuses on the data-storing surface to turn into a reading optical point; and
utilizing a photodetector to receive a reflective beam from the reading optical point and translating the reflective beam to an electric signal.

11. The structure according to claim 10, wherein utilizes the polarizing area and unpolarizing area or different directions of polarization on the data-storing surface to represent digital data 1 and 0.

12. The structure according to claim 10, wherein the pick-up head further comprises a pedestal for fixing the pair of wires so as to control the positions of the ends of the wires.
